(19) United States
(12) Patent Application Publication
(10) Pub. No.: US 2008/0024437 A1
(43) Pub. Date: Jan. 31, 2008

(54) Display apparatus and information processing apparatus

(75) Inventor: Hisao Morooka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/600,118

(22) Filed: Nov. 16, 2006

(30) Foreign Application Priority Data
Jul. 31, 2006 (JP) 2006-208076

(51) Int. Cl. G09G 5/00

(52) U.S. Cl. 345/156

(57) ABSTRACT

The information processing apparatus of the invention includes: a display section having a display screen on one surface thereof; a main unit that supports the display section so that the display section can be opened and closed with the one surface arranged inside, and, when opened, serves as a base to erect the display section; and an input section that is integrated with the main unit to be flush with the main unit with an operating member arrayed on the top thereof. A back surface on the back of the display screen is configured to be shaped like a tray with raised ridges formed on the periphery of the back surface.

### BACKGROUND OF THE INVENTION

1. Field of the Invention

The present invention relates to a display apparatus used for display of information in a computer and other types of electronic apparatuses, and to an information processing apparatus that uses the display apparatus.

2. Description of the Related Art

Typically, a display apparatus (hereafter referred to as “display”) is used to display information in working with a computer.

There are various types of computers, including a desktop computer in which a display is separated from a main unit, and a notebook (laptop) computer in which a display unit is connected by a hinge to a main unit that a keyboard is disposed on.

As such a desktop computer is stationary or installed at a fixed place, it does not need to be so compact, and rather needs a large screen to display information as much as possible for efficient work.

On the other hand, a notebook computer is frequently used by an office worker as it is convenient to carry because of reduction in size when not in use by closing a display section to be overlapped on a main unit and because of being an integrated apparatus that does not require other device to perform data processing. However, emphasis on transportability results in reduction in size of a display section as a computer is miniaturized, leading to deterioration in work efficiency.

Additionally, there is the demand for further transportability of a computer, due to the business trend where a conference using sophisticated wireless network inside a company is encouraged and a worker is not given a fixed seat in the office any more.

When a worker moves with a computer in a company, he or she always carries documents and stationaries together. In this regard, for example, Japanese Patent Laid-Open No. 08-044458 discloses the computer provided with a tray to be pulled out so as to enhance its transportability.

However, the conventional computers have the following problems in terms of improving compactness and transportability: (1) a desktop computer lacks in portability as it is composed of a display, a main unit and a keyboard that are relatively large and disposed separately; (2) a notebook computer has excellent portability, but is inconvenient to carry other articles together; (3) the computer disclosed Japanese Patent Laid-Open No. 08-044458 has transportability by keeping articles in the tray provided in the main unit thereof, but requires widening the thickness of its main unit, which makes the computer large.

### SUMMARY OF THE INVENTION

The present invention has been made in view of the above circumstances, and provides a display apparatus and an information processing apparatus that has excellent transportability.

A display apparatus according to the invention includes:

a display screen disposed on one surface of the display apparatus; and

a back surface opposite to the one surface, the back surface being shaped like a tray with raised edges on a periphery of the back surface.

As the back surface of the display section is configured to have raised edges formed on the periphery thereof and is shaped like a tray, it is possible to carry articles such as documents and stationery placed on the back surface. Accordingly, transportability is enhanced.

Further, an information processing apparatus according to the invention includes:

a display section having a display screen on one surface thereof and a back surface opposite to the one surface, the back surface being shaped like a tray with raised edges on a periphery of the back surface;

a main unit that supports the display section so that the display section can be opened and closed with the one surface arranged inside and, when opened, serves as a base to erect the display section; and

an input section that is integrated with the main unit to be flush with the main unit and has operating members for inputting information arrayed on a top surface thereof.

In the information apparatus of the invention, the display section is capable of opening and closing and its back surface is configured to be shaped like a tray with raised edges formed on the periphery thereof. Accordingly, by closing the back surface to be overlapped over the input section and the main unit, it is possible to carry the apparatus with the back surface at the top while articles are placed on the back surface.

Preferably, in the information processing apparatus, the input section is physically detachably coupled to the main unit.

As the input section provided with the operating members for inputting information is detachable from the main unit, the input section can be moved to be placed in a position convenient for a user to handle. Accordingly, the layout of the PC easy to handle by a user when in use can be achieved.

Further, as the input section can be coupled to the main unit, the apparatus can be easily carried by closing the display section to be overlaid over the input section and the main unit coupled to each other.

Preferably, in the information processing apparatus according to the invention, the input section is a wireless keyboard that wirelessly transmits information input through the operating member to the main unit.

Provision of the wireless keyboard eliminates the need to provide an electrical cord, leading to a more user-friendly apparatus.

As described above, the display apparatus and the information processing apparatus according to the invention can realize excellent transportability.

### BRIEF DESCRIPTION OF THE DRAWINGS

FIG. 1 is a perspective view of a personal computer (hereafter referred to as PC) when opened according to one embodiment of the invention.

FIG. 2 is a right-side view of the PC shown in FIG. 1, when opened.

FIG. 3 is a left-side view of the PC shown in FIG. 1, when opened.

FIG. 4 is a top view of the PC, when opened, shown in FIG. 1.

FIG. 5 is a bottom view of the PC shown in FIG. 1, when opened.

FIG. 6 is a front view of the PC shown in FIG. 1, when opened.

FIG. 7 is a back view of the PC shown in FIG. 1, when opened.

FIG. 8 is a perspective view of the PC shown in FIGS. 1 through 7, when closed.

FIG. 9 is a top view of the PC shown in FIG. 8, when closed.

FIG. 10 is a perspective view of the PC shown in FIG. 1, when opened, as viewed obliquely from above the back side thereof.

### DETAILED DESCRIPTION OF THE INVENTION

Embodiment(s) of the present invention will be described below with reference to the attached drawings.

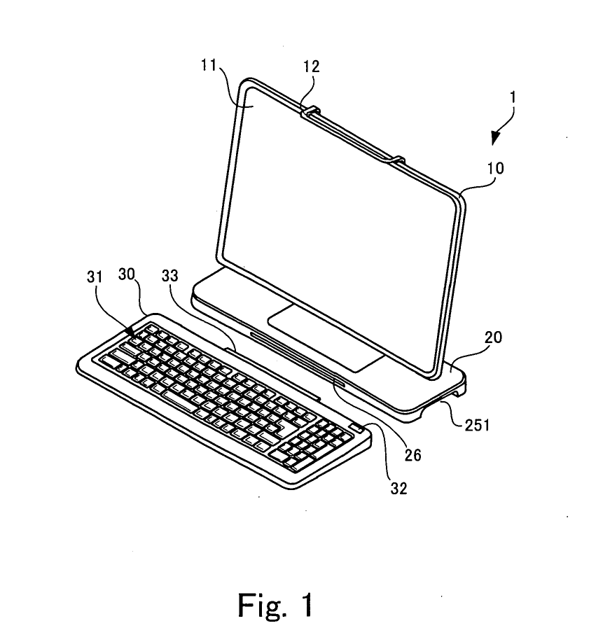

FIG. 1 is a perspective view of a personal computer 1 (hereafter referred to as PC) when opened according to one embodiment of the invention.

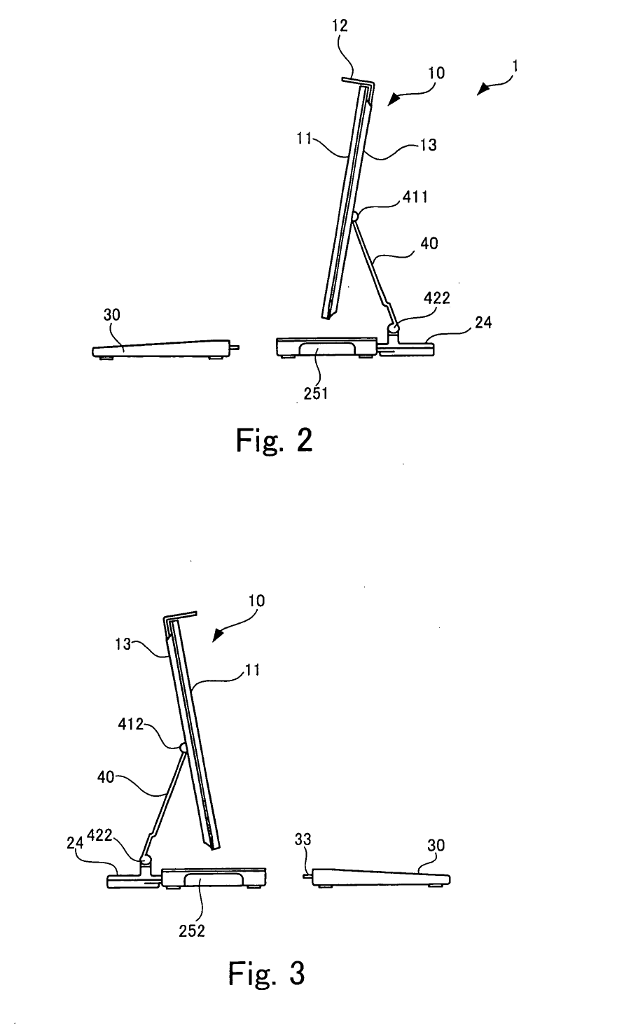

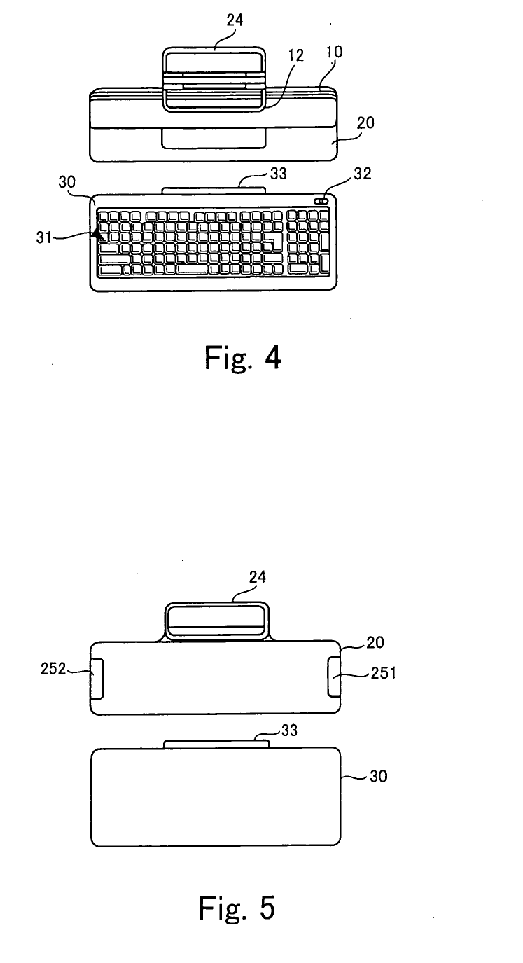

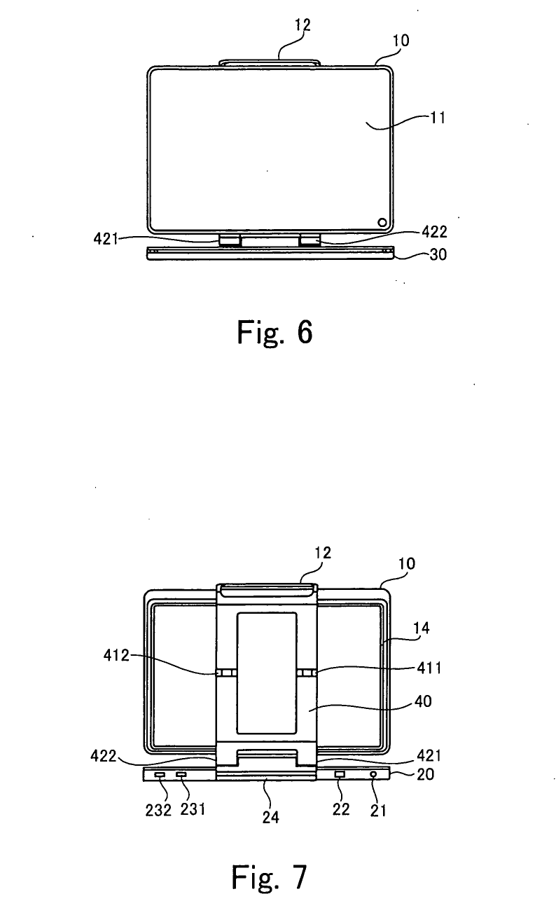

FIG. 2 and FIG. 3 are respectively a right-side view and a left-side view of the PC, when opened, shown in FIG. 1. FIG. 4 and FIG. 5 are respectively a top view and a bottom view of the same, and FIG. 6 and FIG. 7 are respectively a front view and a back view of the same.

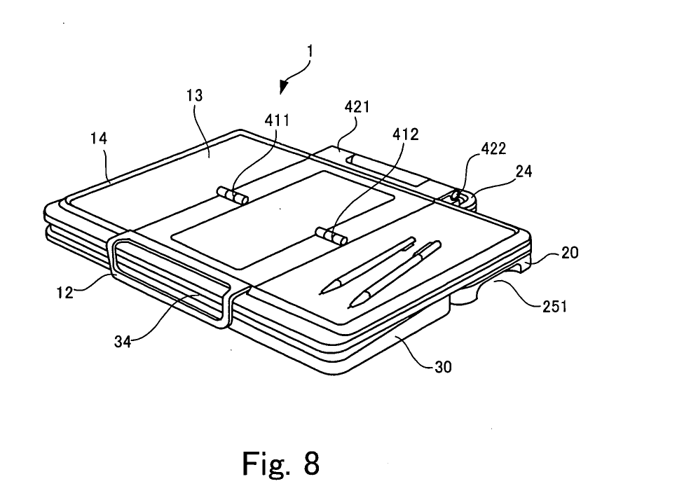

FIG. 8 is a perspective view of the PC when closed shown in FIG. 1 through FIG. 7.

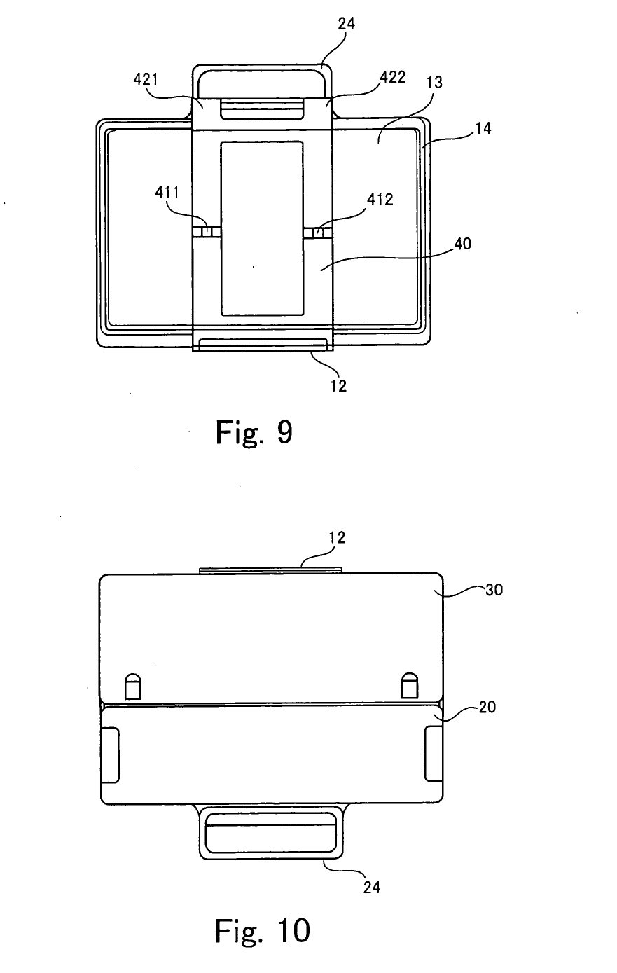

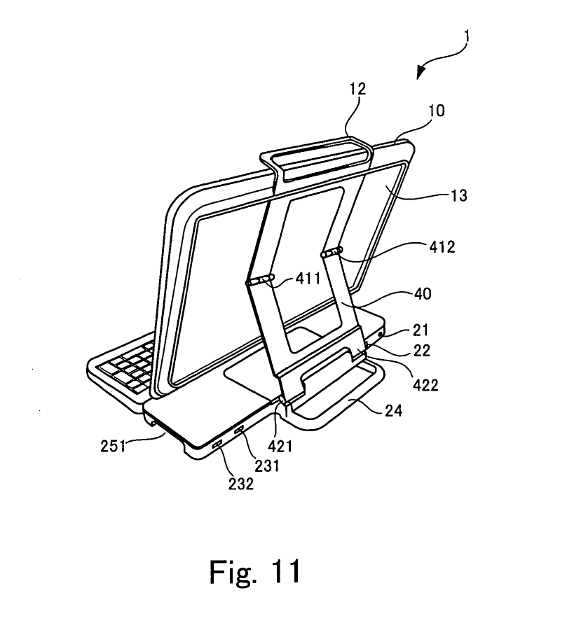

FIG. 9 and FIG. 10 are respectively a top view and a bottom view of the PC when closed shown in FIG. 8.

FIG. 10 is a perspective view of the PC when opened shown in FIG. 1, as viewed obliquely from above the back side thereof.

The PC 1 of FIG. 1 is composed of a display section 10, a main unit 20, and an input section 30.

The display section 10 has a display screen 11, which covers nearly the whole of the surface of the display section 10, and displays an image on the display screen 11 in response to an instruction from the main unit 20.

Additionally, the display section 10 has a claw 12 configured to be positioned at the upper end of the PC 1 when opened, and positioned on the flank of the front side of the PC 1 when closed. The details of the claw 12 will be described later.

The main unit 20 serves as a base to erect the display section 10 when opened as well as holds the display section 10 in such a way that the display section 10 can be opened and closed with the surface of the display screen 11 arranged in the front side of the display section 10. In the embodiment, the display section 10 is supported via a supporting member 40 by the main unit 20 so as to be opened and closed.

More particularly, a back surface 13 of the display section 10 is rotatably held by one end of the supporting member 40 via hinges 411 and 412, while the other end of the supporting member 40 is rotatably held by the main unit 20 via hinges 421, 422.

The hinges 411, 412 disposed at the display section 10 holds the display section 10, by their friction, at any angle within the rotation range of the display section 10, while the hinges 421, 422 are rotatably held by their friction at any angle within the rotation range thereof by the main unit 20. Accordingly, the main unit 20 is capable of supporting the display section 10 via the supporting member 40 so that the display section may be kept in a position of any height and angle within the rotation range relative to the main body 20.

Although the main unit 20 performs data processing by a CPU and the like incorporated therein, the PC 1 in the embodiment is a thin client computer and thus does not have a large-capacity memory device such as a magnetic disc installed therein. However, the invention is not limited to a thin client computer, and may be applied to other types of PCs having a hard disc device and the like installed therein.

As shown in FIG. 11, the main unit 20 in the embodiment has, on the flank of the back side thereof, various connecting portions, including an AC adapter connecting portion 21 to receive an AC adapter, a LAN connector connecting portion 22 to receive a LAN (Local Area Network) connector, and two USB connector connecting portions 231, 232 to receive a USB (Universal Serial Bus) connector respectively. Also on the flank of the back side of the main unit 20, there are a handle 24 to lift the PC 1 with a hand. Additionally, on the flanks of the right and left sides of the main unit 20, there are recesses 251, 252 to place fingers therein when lifting the PC 1. Further, a connecting portion 26 to receive the input section 30 is disposed on the flank of the front side of the main unit 20.

On the top surface of the input section 30, arrayed are plural keys 31 for inputting information that is wirelessly transmitted to the main unit 20. Near the right corner of the top surface of the input section 30, a fingerprint sensor 32 is disposed for use in authentication. Further, a connecting portion 33 to be coupled to the connecting portion 26 is disposed on the flank of the back side of the input section 30.

The input section 30 is configured to be detachably connected to the main unit 20. In other words, the input section 30 is capable of being detached from the main unit 20 as shown in FIG. 1 as well as being connected to the main unit 20 as shown in FIG. 11, by making the connecting portion 33 of the input section 30 coupled to the connecting portion 26 of the main unit 20. With the input section 30 coupled to the main unit 20 and the display section closed, the PC 1 has such a configuration, as shown in FIG. 8, that the length of the display section 10 in a direction of the depth of the display section, that is, from the front side to the back side thereof, is substantially same as the sum of the length of the main unit 20 and the input section 30 in the same direction.

When the PC 1 is carried, the input section 30 is coupled to the main unit 20 as shown in FIG. 8 and the display section 10 is closed to be overlaid on the input section 30 and the main unit 20 that are connected with each other. The embodiment assumes the following two ways of carrying the PC 1.

One way is to lift the PC 1 with hands, by placing fingers in the recesses 251 and 252, with the back surface 13 of the display section 10 positioned at the top and the front end of the front side of the display section positioned in front of a user. This way is suitable for carrying the PC 1 in a relatively short range, for example, within a room, or, to an adjacent room.

The back surface 13 of the display section 10 has, as shown in FIG. 8, raised edges 14, and thus the whole of the back surface 18 is shaped like a tray. Accordingly, it is possible to prevent falling of articles such as documents and stationery placed on the back surface 13 when carried together with the PC 1.

The other way is to hold the handle 24 with a hand, with the PC 1 positioned vertical. This way is suitable for carrying the PC 1 in a relatively long range.

When the display section 10 is closed after the input section 30 being coupled to the main unit 20, the claw 12 is positioned on a flank 34 of the front side of the input section 30 so as to push and hold the flank 34. Accordingly, it is possible to prevent detachment of the input section 30, due to disengagement of the connection portion 33 of the input section 30 from the connection portion 26 of the main unit, even when the PC 1 is lifted to be carried by holding the handle 24 with a hand. Thus, safe transportation of the PC 1 is ensured.

What is claimed is:

1. A display apparatus comprising:
a display screen disposed on one surface of the display apparatus; and
a back surface opposite to the one surface, the back surface being shaped like a tray with raised edges on a periphery of the back surface.

2. An information processing apparatus comprising:
a display section having a display screen on one surface thereof and a back surface opposite to the one surface, the back surface being shaped like a tray with raised edges on a periphery of the back surface;
a main unit that supports the display section so that the display section is capable of opening and closing with the one surface arranged inside and, when opened, serves as a base to erect the display section; and
an input section that is integrated with the main unit to be flush with the main unit and has operating members for inputting information arrayed on a top surface thereof.

3. The information processing apparatus according to claim 2, wherein the input section is physically detachably coupled to the main unit.

4. The information processing apparatus according to claim 3, wherein the input section is a wireless keyboard that wirelessly transmits information input through the operating member to the main unit.
